(19) United States
(12) Patent Application Publication
(10) Pub. No.: US 2011/0050076 A1
(43) Pub. Date: Mar. 3, 2011

(54) PLASMA GENERATOR FOR ELECTROTHERMAL-CHEMICAL WEAPON SYSTEM COMPRISING IMPROVED CONNECTORS, AND METHOD FOR PREVENTING THE ELECTRICAL CONTACT OF THE PLASMA GENERATOR FROM BEING BROKEN

(75) Inventors: Lennart Gustavsson, Karlskoga (SE); Ola Stark, Hammaro (SE)

(73) Assignee: BAE SYSTEMS BOFORS AB, KARLSKOGA (SE)

(21) Appl. No.: 12/934,174

(22) PCT Filed: Mar. 23, 2009
(86) PCT No.: PCT/SE09/00150

§ 371 Date: Nov. 18, 2010

(30) Foreign Application Priority Data
Apr. 1, 2008 (SE) 0800732.0

(51) Int. Cl. H05H 1/24

(52) U.S. Cl. 313/231.31

(57) ABSTRACT

The invention relates to a plasma generator (4, 4′) for electrothermal and electrothermal-chemical weapon systems, which plasma generator comprises a combustion chamber (20) having a combustion chamber channel, and a center electrode (24, 24′) disposed inside the combustion chamber channel (20′), which combustion chamber and center electrode are electrically conductive and each comprise a respective first connector (26, 42′, 33, 45′) for an electrical connection to a respective second connector (14c, 49, 14d, 48), interacting with the respective first connector, on the back piece of the weapon system. The connector (42′) belonging to the combustion chamber and the connector (45′) belonging to the center electrode are axially displaceable relative to each one of the connectors (48, 49) belonging to the back piece (14), with a maintained, radial contact between the first and the second connectors (42′, 45′ and 48, 49). The invention also relates to a method for maintaining the electrical contact of the plasma generator.

### TECHNICAL FIELD

The present invention relates to a plasma generator for electrothermal and electrothermal-chemical weapon systems, which plasma generator comprises a combustion chamber having a combustion chamber channel, and a center electrode disposed inside the combustion chamber channel, which combustion chamber and center electrode are electrically conductive and each comprise a respective first connector for an electrical connection, in the use of the plasma generator in the weapon system, to a respective second connector, interacting with the respective first connector, on the back piece of the weapon system.

The present invention also relates to a method pertaining to a plasma generator for electrothermal and electrothermal-chemical weapon systems, which plasma generator comprises a combustion chamber having a combustion chamber channel, and a center electrode disposed inside the combustion chamber channel, which combustion chamber and center electrode are electrically conductive and each comprise a respective first connector for an electrical connection, in the use of the plasma generator in the weapon system, to a respective second connector, interacting with the respective first connector, on the back piece of the weapon system, in order to prevent the contact of the plasma generator with the back piece of the weapon system from being broken by vibrations and recoils occurring in connection with the use of the weapon system, through the formation of an axial clearance between a rear end face of the first connectors on the plasma generator and a front end face of the second connectors on the back piece of the weapon system.

Background of the Invention, Problem Definition and Prior Art

In a conventional barrel weapon, i.e. here a weapon which comprises a barrel and in which weapon a projectile is fired and propelled along the barrel by a propellent charge which is ignited with the aid of a percussion primer/priming cartridge, such as, for example, in artillery ordnance, in tank and other combat vehicle guns, in anti-aircraft defense, etc., an attained higher initial velocity (V₀) for the projectile is utilized to, for example, increase the range of the weapon, improve the penetrability of the projectile and reduce the period of flight of a projectile in order thereby to make it easier to attack targets which make avoidance maneuvers. The term ‘percussion primer’ denotes a priming device which either mechanically or electrically ignites the propellent charge. The term ‘initial velocity (V₀)’ denotes, here, the velocity of the projectile as it leaves the barrel muzzle of the weapon, and is therefore also hereinafter referred to as the muzzle velocity (V₀) of the weapon. The term ‘propellent charge’ denotes a deflagrating compound or deflagrating agent, hereinafter referred to as a propellant, for example gunpowder, in the form of a charge which, upon combustion, releases propellent gases, which propellent gases form a strong gas overpressure inside the barrel and which gas overpressure forces the projectile toward the barrel muzzle. The higher the gas overpressure and the longer-lasting the effect of this gas overpressure upon the barrel projectile, the higher the muzzle velocity can be.

Great efforts have been made and continue to be made to obtain a higher and higher muzzle velocity (V₀) of this type for all barrel projectiles, regardless of type, in order to further improve the aforementioned advantageous parameters. For example, the muzzle velocity (V₀) can be raised by enlarging the propellent charge for each ammunition shot, so that a greater quantity of energy can thus be utilized to propel the projectile. The increase in velocity which is thereby possible is, however, relatively limited. One reason for the limited increase in velocity is that an extra quantity of supplied propellent charge, inclusive of the thereby formed propellent gases, has also to be accelerated together with the projectile, so that some of the energy from the extra quantity of supplied propellent charge is used for this, in addition to the fact that all the propellent charge which is unburnt when the projectile leaves the barrel provides no increase in velocity, since the gas overpressure drops to the ambient atmospheric pressure as soon as the projectile has left the barrel. There can also be a problem in being able to fill conventional ammunition shots with all the quantity of propellent charge which is required to attain the desired muzzle velocity and, at the same time, to accommodate the actual projectile without heavily increasing the total weight of the ammunition shots. If the propellent charge accommodated inside the ammunition shot does not have a burning time equivalent to the length of the barrel, the maximum velocity of the projectile can thus already be reached before the projectile has left the barrel, since the propellent manages to burn itself out beforehand.

Thus the optimal propellent charge, regardless of the size of the propellent charge and the attained propulsion velocity of the propellent charge, must burn as fast as the time it takes to drive the projectile out of the barrel, so that a limiting factor for the maximum size of the propellent charge is the barrel length of the weapon. At the same time, it is also the case, of course, that the longer the barrel, the heavier and more unwieldy the weapon, so that the desired maneuverability of the weapon and the total weight of the weapon in turn limit the optimal barrel length and the material length of the barrel. Together with the material properties of the material with respect to, for example, compressive strength, fatigue, wear, etc., the material thickness of the barrel gives the maximally permitted barrel pressure Pₘₐₓ of the barrel.

In order to prevent the gas overpressure from becoming so large that the barrel is damaged, i.e. that the maximally permitted barrel pressure for the barrel is exceeded, which in the worst case could mean that the barrel is burst, the capacity of the propellent charge to generate propellent gas during the actual ignition of the propellent charge and at the start of the propulsion of the projectile through the barrel is therefore kept to a relatively low level, so that the volume of the initially generated propellent gas is small compared with the total gas volume which has been generated once the propellent charge has finished burning as the projectile leaves the barrel muzzle.

In order to compensate for a space behind the projectile accelerated by the propellent gases, which space steadily increases inside the barrel, and to prevent an unwanted pressure loss, which would otherwise ensue from the increased space and which would arise unless the gas overpressure were constantly maintained at said maximally permitted barrel pressure by higher accelerating gas formation via the increasingly rapid combustion of the propellent charge, the quantity of generated propellent gas per unit of time must therefore increase very strongly throughout the propulsion through the barrel, so as to reach its maximum just before the projectile leaves the barrel (see examples of pressure curves in FIG. 8).

An accelerating gas formation of this type can be realized through the use of different so-called progressive propellent charges, i.e. propellent charges having a combustion process in which the propellent charge burns increasingly rapidly toward the end of the combustion process, whereby more and more propellent gas is formed ever more quickly.

The propulsion velocity and acceleration of the projectile thus increase in line with the acceleration of the combustion process and gas formation, wherein the maximum muzzle velocity (V₀) for the projectile with each particular barrel length would be optimized if the gas pressure behind the projectile throughout the course of the propulsion through the barrel were the same as the maximally permitted barrel pressure Pₘₐₓ of the barrel.

A pressure curve over time for an optimal combustion process would therefore exhibit a virtually immediate pressure increase to Pₘₐₓ, followed by a lengthy plateau phase with a maintained constant barrel pressure at Pₘₐₓ throughout the time for which the propellent charge is burning inside the barrel, i.e. said burning time of the propellent charge, so as then to fall immediately to zero as the projectile leaves the barrel. All the propellent charge will normally then have burnt up. Certain types of shell can however be equipped with so-called base-bleed units, in which the shell is propelled over a further distance, with the aid of a small gunpowder gas motor, even after the shell has left the barrel.

A known way of obtaining said progressive propellent charge is to use various types of propellant mixtures in the same propellent charge, in which more and more chemically progressive propellants are ignited and burnt the further forward in the barrel the projectile has been driven, which then produces the desired increasingly rapid combustion and the accelerating propellent gas formation during the burning time available for the barrel length. The propellent charge can also be chemically surface-treated with so-called inhibitors, so that the combustion of the propellent charge proceeds more slowly at the start until the surface treatment has burnt up, whereafter the remainder, i.e. the untreated part of the propellent charge, burns without hindrance, so that a propellent charge which initially is actually more powerful than Pₘₐₓ can be utilized.

Another way of producing a progressive propellent charge is by gradually increasing the free burning surface of the propellent charge during the actual combustion thereof by multiperforating the various charge units of the propellent charge with a greater number of burning channels, so that a so-called multihole gunpowder is obtained. These burning channels are arranged a predefined mutual distance apart, at a certain depth into the propellent charge or passing continuously through it, with a certain set cross section, and are arranged in certain set patterns in order to be able, via the thereby realized combustion of the propellent charge, to increase the free burning surface available for the combustion not only from the outside of the propellent charge but also from the inside of the burning channels. The burning surface inside the burning channels increases strongly as the burning channels are gradually widened as a result of the combustion. The greater the increase in burning surface, the faster the combustion of the propellent charge and thus the higher and higher the so-called progressivity.

By varying the mutual distances, the depth, the cross section and the pattern of said multiperforation, supplemented by said use of diverse inhibitors, it is attempted to control the acceleration of the propellent gas formation in a manner which is desired for the propulsion of the projectile and to do this in such a way that the propellent charge manages to burn itself out within the desired burning time, i.e. just as the projectile leaves the barrel muzzle.

Yet, in spite of the aforementioned efforts to improve the current conventional propulsion methods and the propellent charges which are utilized for these, the practically possible upper limit for the muzzle velocity in the conventional barrel weapons, and then also for the chemically progressive, inhibited and perforated multihole gunpowders, has been reached at about 1500-1800 m/s. This is due to the fact that the chemical progressivity of the currently known propellent charges has an upper limit and since the multiperforation of the constituent propellent charges cannot currently be carried out, however finely powdered. Moreover, these measures, inclusive of said inhibition, are not very easy to pre-calculate and execute such that the desired pressure curve, for each fired type of propellent charge, always remains exactly the same each time. It will be appreciated that the firing accuracy of the projectile is impaired if the muzzle velocity cannot always be predetermined for each fired shot. The maximum muzzle velocity depends, however, on the particular weight of the projectile, so that the limits vary in accordance with the ammunition type, for example the lower muzzle velocity hereinabove relates to dart ammunition with 40 mm caliber.

There is therefore a strong desire to come up with new propulsion principles and new ammunition of a different type than the above-described purely combustion-gas-driven propulsion of the ammunition, which propulsion principles and which new ammunition give the desired considerably higher initial velocity for the fired projectile, i.e. a velocity at the outlet of the barrel of around 1800-2500 m/s, depending on ammunition type and caliber, and assuming an unchanged projectile weight and total weight for the particular ammunition. Said new ammunition relates, for example, to armor-piercing dart ammunition intended for varying weapon systems comprising a number of different calibers.

A number of new propulsion principles of this type are currently under development for producing said desired higher initial velocity for different sorts of projectiles. The main division of these propulsion principles is based on whether the propulsion occurs by means of gas drive, via electrical drive or via combinations of these two propulsion methods.

Examples of said gas drive are, on the one hand, where the propulsion is based on traditional combustion gas drive but where the projectile also has an accompanying extra propellent charge for the generation of propulsion gases also outside the barrel, for example the aforementioned base-bleed unit, and, on the other hand, where gases other than gunpowder gases, such as reactive or inert gases, are utilized for the gas drive. The term ‘inert gas’ denotes, here, a gas which does not normally participate in any chemical reaction occurring in the gas drive.

Examples of electrical drive are substantially fully electrically driven rail or coil guns. Typical characteristics of these electrically driven weapon systems are that they are intended to utilize electromagnetic pulses for the propulsion of custom-made projectiles.

Examples of combinations of said two main principles for the propulsion of projectiles are constituted by, on the one hand, electrothermal propulsion (ET), in which the supply of electrical energy to a narrow, tubular combustion chamber gives a material ablation from the inside of the combustion chamber, which ablation, possibly together with said inert and/or energetic gas, forms a very hot, electrically conductive plasma and thus a large overpressure for the driving of the projectile and, on the other hand, electrothermal-chemical propulsion, (ETC), see, for example, U.S. Pat. No. 7,073,447, in which the chemical energy from the combustion of the propellent charge which is present in this case is utilized together with the additional electrothermal energy supplied according to the above.

Once a substance has been heated to form the plasma, the component parts of the molecules are separated, that is to say: the sub-molecules or electrons move freely in relation to one another, and to the nucleus of the substance, so that both positive and negative, and thus electrically conductive, ions/charges are formed. Somewhat more concisely, it can be said that an

ETC weapon is constituted by an at least partially gunpowder-gas driven weapon, in which the total propulsion energy for the projectile receives at least a somewhat basic energy boost via the supply of extra electrical energy from a high-voltage source via the plasma formed inside the combustion chamber. A gunpowder-gas driven gun which is only fired by means of an electrical glow ignition of the propellent charge does not therefore constitute an ETC gun.

In the hitherto known electrothermal-chemical weapon systems, the conventional percussion primer is replaced with a plasma generator comprising said combustion chamber. An immediate advantage is that the ignition is more temporally exact compared with the traditional percussion primer in which the reaction time for the ignition varies. The plasma generators can be divided into two separate main types, whereof one type, hereinafter referred to as a plasma jet burner, delivers a singular axial plasma jet out of the free end orifice of the plasma jet burner, whilst the other type comprises a radially multipole tube similar to a flute, and therefore also referred to as a “piccolo”, having a number of openings for the plasma arranged along the shell surface of the tube. The “piccolo” normally has no end orifice opening, so that, compared with the plasma jet burner, the same powerful plasma jet which is directed forward in the longitudinal direction of the plasma jet burner cannot be formed. Both types of plasma generator comprise an electrically conductive conductor for the formation of the plasma, which electrically conductive conductor is heated, gasified and ionized via a very powerful, short electrical energy pulse, whereupon the produced plasma flows out through the openings of the tube, or the end orifice opening of the plasma jet burner, with a very high pressure and temperature, normally several hundred MPa, preferably about 500 MPa, and in which the temperatures vary between high and extremely high, i.e.

normally between about 3,000° K and 50,000° K, in which 3,000° K represents the temperature reached with the conventional chemical propellent charges. Preferably, however, the plasma temperatures lie between about 10,000° K and 30,000° K.

The very high temperature of the plasma affects the combustion of the propellent charge in several positive ways. For example, at said plasma temperatures, a much more complete combustion of the propellants of the propellent charge is obtained than is the case at the normally considerably lower temperatures of the conventional combustion. This is combined with the fact that the propellants are converted into the plasma to a higher degree, since the propellants are broken down into smaller molecules, whereby more energy is extracted from the same quantity of propellent charge. This increased energy quantity thus gives the sought-after additional increase in muzzle velocity for the projectile.

Since the propellent charge, moreover, burns faster at the higher temperature of the plasma, a larger propellent charge has time to be burnt before the projectile leaves the barrel, so that the propellent charge quantity can be increased, provided that the cartridge case has space for this, for each given ammunition shot, and thus a further increased energy quantity is obtained for the raising of the muzzle velocity. Specially produced gunpowder types with greater density, higher energy content and lower molecular weight for the propellent gases, which gunpowder types are not normally used or cannot be ignited with conventional percussion primers, can be utilized.

Due to the very high temperature and also the very high internal pressure inside the plasma generator, the combustion chamber of the plasma generator, as well as the barrel, will be subjected to very large heat and load stresses. These stresses are directly dependent on the pulse length and amplitude of the electrical energy, a long pulse length, i.e. the period of duration of the electrical energy pulse, generating more heat and greater stresses than a short pulse length. The long pulse length is disadvantageous, however, with respect to the supplied greater quantity of energy for the acceleration of the projectile, so that a solution to this heat problem is to provide the channel walls of the combustion chamber with an internal, highly heat-resistant insulating material, for example a ceramic which is also electrically insulating. It is previously known to utilize on the inside of a barrel, and in various positions in the longitudinal direction of the barrel, ceramic coatings or inserts to prevent the transfer of electrical energy from an electrical primer to a barrel body, which, however, entails quite different problem solutions than for the prevention of heat and load stresses inside plasma generators.

However, document U.S. Pat. No. 4,957,035, for example, shows an ET weapon comprising a ceramic multichannel, conical plasma jet burner, which is screwed in the back piece of the ET weapon and in which a light arc is generated between a rear center electrode and a front annular electrode in each ceramic combustion chamber channel. A very hot plasma under high pressure is thereby produced in the combustion chamber channels connected to the barrel, which pressure drives the projectile disposed in the barrel out of the same. The highly heat-resistant and electrically insulating ceramic walls of the combustion chamber channels protect against the extreme heat and electrically insulate the two electrodes from each other, and the combustion chamber channel from the rest of the plasma jet burner.

The ceramics are characterized by a relatively good compressive strength, but they have a low strength otherwise. In particular, the ceramics have a low tensile strength. The very high internal pressure, about 500 MPa, inside the ceramicized combustion chamber channels, which is caused by the hot plasma, results in an expansion of the ceramic against the walls of the combustion chamber channels. If there happens to be any clearance at all between the ceramic and the walls of the combustion chamber channels, or if the combustion chamber channels yield, i.e. are expanded, to the pressure, tensile stresses will inevitably arise in the ceramic. In the aforementioned plasma jet burner, U.S. Pat. No. 4,957,035, these tensile stresses would easily tear apart the ceramic and cause serious leakage of heat, current, voltage and/or plasma, resulting in inevitable damage to the weapon, if the strength of the plasma jet burner had not been mechanically improved via the axial force with which the conical plasma jet burner is screwed into a corresponding conical and inflexible space and is thus clamped tight. The intention is that this mechanical squeezing into the conical space of the plasma jet burner, at least to a certain extent, will attempt to counteract said tensile stresses in the ceramic, which has not, however, been wholly successful.

In another shown embodiment, an attempt has been made to further reinforce and seal the plasma jet burner by winding a fiberglass plastic around its outside. Despite these measures, this conical screw fastening nevertheless gives an unsatisfactory result. In particular, the problems with the clearances between the ceramic and the walls of the combustion chamber channels, which clearances are formed by material irregularities and fault tolerances, and with the fact that the mutually interacting conical components must be very precisely made in order to fit together without play, thereby making the components expensive to produce, still persist.

It will be appreciated, moreover, that as a result of the conical shape, something has in principle been designed that can best be likened to a champagne cork which is merely awaiting an increase in internal pressure in order for the whole construction to explode.

The conical screw fastening therefore constitutes an expensive and, in production engineering terms, time-consuming and complicated way of solving the problems with the tensile stresses in the ceramic. In the second shown embodiment, the aforementioned negative parameters are further aggravated with the outer fiberglass plastic winding, which fiberglass plastic winding can best be likened to a further emergency measure taken in a laboratory construction.

Since the ceramic is electrically insulating, moreover, in the currently known plasma generators of this type there is a need for an electrically conductive conductor, generally a metal filament or metal foil, between the electrodes to allow the start-up of the electrical light arc and the plasma subsequently formed by means of the electrical energy. Since this electrical conductor is gasified into gaseous form with the start-up and disappears from the plasma generator, and the ceramic prevents ablation from the channel walls, a continued electrical energy supply is made more difficult or prevented should the plasma cool or die down. Moreover, even with just somewhat longer pulse lengths, of just a few milliseconds, such extremely high temperatures arise that the plasma generator risks suffering damage in spite of the ceramic. At the same time, it is desirable to have the facility, via a long-lasting plasma, to precisely control the combustion of the propellent charge and the electrical energy supplied to the propulsion gases. The aforementioned conical construction quickly becomes leaky and thus unusable, so that the construction constitutes a disposable weapon.

In order to precisely be able to control the supply of electrical energy and thus be able to further raise the muzzle velocity of an ETC weapon, there is therefore a strong desire to find a safe way, in a ceramically electrically insulated combustion chamber channel of a plasma generator, both to ensure the plasma generation and to heavily extend the pulse length, ideally at least tenfold in relation to hitherto possible pulse lengths, and at the same time the plasma generation and the longer pulse length must not be allowed to crack the ceramic, and the construction must not become expensive or undesirably complicated.

A further basic problem with the currently customary ETC weapons is that they utilize the barrel as a counter electrode, so that these constructions also impart current or voltage to the actual barrel and thus to other basic parts of the particular weapon system. In addition to obvious drawbacks with this, such as the risk of personal injury due to the electrical danger and short-circuiting of the weapon system, it will be appreciated that there is a substantial risk of a metallic cartridge case being welded fast in the barrel when current and voltage is transmitted to the weapon. Moreover, sensitive electronic equipment can be damaged by unwanted electrical transmissions and ensuing magnetic fields.

Patent specification U.S. Pat. No. 6,186,040 describes a known plasma jet burner for electrothermal and electrothermal-chemical gun systems, in which necessary current and voltage is transmitted to the plasma jet burner via its rear part and then onward to the actual barrel. In one of the shown embodiments, said metallic cartridge case is instead made of a non-conductive material, but as the barrel is utilized as a counter electrode the barrel will continue to be live and the cartridge case is in this case at risk of fusion.

A further serious effect of the shown construction is that the contact, i.e. the contact surface between the electrical connectors of the weapon, disposed in the back piece, and the corresponding connectors of the plasma jet burner, is minimal, so that the recoil and other vibrations of the weapon during use of the weapon give rise to a small clearance between said connectors, so that a light arc can be generated which welds the connectors together. The whole of the weapon is therefore at risk of becoming a disposable weapon which can only be fired once.

Object of the Invention and its Characterizing Features

One object of the present invention and its various embodiments is to provide a substantially improved plasma generator for electrothermal and electrothermal-chemical weapon systems, which plasma generator makes it possible to automatically shoot a number of successive ammunition shots and in which a number of energy pulses can be delivered from the plasma generator in each ammunition shot without the electrical connectors between the back piece of the weapon and the plasma generator being at risk of burning and sticking fast due to the clearance and the ensuing light arc between the connectors that can be formed by the vibrations associated with the use of the weapon, the plasma generator being able to be better utilized than previously to attain increasingly high muzzle velocities for varying types of projectile.

Said objects, and other aims which are not listed here, are satisfactorily met within the scope of that which is stated in the present patent claims.

Thus, according to the present invention, an improved plasma generator for ammunition shots for electrothermal and electrothermal-chemical weapon systems has been provided, which is characterized in that the connector belonging to the combustion chamber and the connector belonging to the center electrode are axially displaceable relative to each one of the connectors belonging to the back piece, with a maintained, radical contact, via each lamellar contact, between the first and the second connectors during the axial displacement.

According to further aspects of a plasma generator according to the invention:

the connector belonging to the combustion chamber and the connector belonging to the center electrode, together with one each of the connectors of the back piece, each constitute a respective connector pair, which connector pairs each comprise, disposed on their respective connector, a radially disposed, electrically conductive lamellar contact and a radially disposed, electrically conductive sliding surface, which lamellar contact and sliding surface are axially displaceable relative to each other to produce said maintained, radial contact between the first and the second connectors during the axial displacement;

the lamellar contacts are disposed one on the connector belonging to the combustion chamber and one on the connector belonging to the center electrode, and the sliding surfaces are disposed one on one each of the connectors belonging to the back piece;

the combustion chamber channel extends axially through the combustion chamber, a flange is disposed on an outer, rear end of the combustion chamber, an orifice closure is disposed on a front end of the combustion chamber, an electrically insulating ceramic tube is disposed inside the combustion chamber channel between the rear end of the combustion chamber and the orifice closure, and the electrically conductive center electrode is disposed inside the electrically insulating ceramic tube;

the connector of the combustion chamber is comprised of an outer lamellar contact disposed on the flange of the combustion chamber, and the connector of the center electrode is comprised of an inner lamellar contact disposed inside the center electrode;

the outer lamellar contact comprises an outer lamellar contact strip, which is fitted radially on the flange;

the outer lamellar contact strip is fitted in a radial groove enclosing the periphery of the flange;

the outer lamellar contact strip is comprised of a conductive material, for example copper;

the outer lamellar contact strip comprises resilient lamellae for providing good bearing contact against the therewith interacting connector on the back piece, in which connector the flange is intended to be inserted over a certain set axial distance, preferably exceeding the flange thickness;

the inner lamellar contact comprises a cavity arranged inside the center electrode and intended for the connector of the back piece, and an inner lamellar contact strip fitted on the radial inner surface of the cavity;

the inner lamellar contact strip comprises resilient lamellae for providing good bearing contact against the therewith interacting connector on the back piece, which connector is intended to be inserted in the cavity over a certain set axial distance, preferably exceeding the thickness of the flange;

the inner lamellar contact strip is comprised of a conductive material, for example copper.

The improved method for preventing the contact of the plasma generator with the back piece of the weapon system from being broken by vibrations and recoils occurring in connection with the use of the weapon system, through the formation of an axial clearance between a rear end face of the first connectors on the plasma generator and a front end face of the second connectors on the back piece of the weapon system, is characterized in that the connector belonging to the combustion chamber and the connector belonging to the center electrode, upon said vibrations and recoils, are axially displaced relative to each one of the connectors belonging to the back piece, so that the axial clearance is formed, at the same time as an unbroken contact is maintained radially between the first and the second connectors during said axial displacement.

According to further aspects of a method according to the invention:

the maintained, unbroken contact between the first and the second connectors is made possible by the fact that the connectors of the combustion chamber and of the center electrode bear against and interact with one each of the connectors of the back piece along a radial contact surface whose axial width exceeds the axial clearance between the end faces of the first and the second connectors, to which the use of the weapon system gives rise,
the maintained, unbroken, radial contact between the first and the second connectors, in which the connector belonging to the combustion chamber and the connector belonging to the center electrode, together with one each of the connectors belonging to the back piece, form a respective connector pair, is realized by the fact that, arranged one on one each of the first connectors and one on one each of the second connectors in each connector pair, a radially disposed, electrically conductive lamellar contact bears against and interacts with a likewise radially disposed, electrically conductive sliding surface, which lamellar contact and sliding surface are axially displaced relative to each other such that said maintained, radial contact between the first and the second connectors is achieved during the axial displacement.

Advantages and Effects of the Invention More energy pulses and pulse intervals are enabled

during the course of the propulsion of the projectile through the whole of the barrel, whereby the electrical energy supplied to the propulsion gases can be more accurately controlled. More pulses give the chance of constant pressure at Pₘₐₓ for a much longer period. The stresses which are directly dependent on the pulse length of the electrical energy, i.e. the period of duration of the electrical energy pulse, diminish if the electrical energy can be divided into a number of pulse intervals, which pulse intervals then generate less heat and less stresses than a single long pulse length. The combined pulse length can then considerably longer than previously.

The problems with the impartation of current and voltage to the barrel, as well as with the burning fast of the cartridge case in said barrel, are resolved by the electric current being introduced via the center electrode of the plasma generator and removed via the flange of the combustion chamber, without the barrel being involved in the circuit. If the cartridge case, moreover, is dielectric, this positive characteristic is reinforced.

When the invention is applied in desired weapon applications, the risk of flash-over/short-circuiting, as well as the burning fast of the plasma generator against the connectors in the wedge, will be very substantially reduced or wholly eliminated, since the current/voltage follows the easiest path through the plasma generator, i.e. via the center electrode and the formed plasma, whereafter the current/voltage is fed back via the outer shell of the plasma generator to the rear end of the combustion chamber, and via lamellar contacts disposed on the flange to the connectors of the wedge. The rear end of the plasma generator, which is normally threaded onto the cartridge case, can, moreover, be electrically insulated from the cartridge case in the manner described below, or else the whole of the cartridge case, or at least its bottom or bottom piece, is made of an electrically insulating material.

The connectors which are used as input and output conductors are of the lamellar contact type comprising lamellar contact strips, so that they can cope with relatively large vibrations and recoil of the weapon without the contact being worsened, which is the case where contacts of the point-contact type are used, as is further explained below. The barrel and the back piece/the wedge in the particular weapon cannot therefore be live when the firing is carried out.

The unique configuration of the lamellar contacts thus makes this plasma generator very suitable for automatically firing a number of successive energy pulses and also for firing a number of energy pulses for each ammunition shot of this type, since the lamellar contacts easily cope with the normally occurring vibrations associated with the use of the weapon without the clearance and the ensuing light arc between the connectors threatening to materialize, which light arc can otherwise cause the connectors to weld together.

### LIST OF FIGURES

The invention will be described in greater detail below with reference to the appended figures, in which:

FIG. 1 is a schematic perspective view of an ammunition shot for an electrothermal-chemical weapon system, which ammunition shot incorporates a plasma generator according to the present invention.

FIG. 2 is a schematic longitudinal section through parts of the ammunition shot according to FIG. 1, which ammunition shot comprises the plasma generator, parts of a propellent charge and a projectile enclosed in a cartridge case.

FIG. 3 is a schematic longitudinal section through parts of an electrothermal-chemical weapon for firing an ammunition shot by means of a plasma generator according to FIG. 4.

FIG. 4 is a schematic longitudinal section through parts of a plasma generator.

FIG. 5 is a schematic perspective view of a turret for a combat vehicle, in which combat vehicle an electrothermal-chemical weapon system comprising a plasma generator according to the invention is used.

FIG. 6 shows schematically a perspective view of an alternative cartridge case for use with the ammunition shot comprising a plasma generator according to the invention.

FIG. 7 is a schematic longitudinal section through the cartridge case according to FIG. 6.

FIG. 8 shows schematically pressure curves relating to a firing of a plasma generator according to the invention.

FIG. 9 shows a schematic longitudinal section through parts of an embodiment of the plasma generator according to the invention, comprising connectors of the lamellar contact type, in which the connectors of the back piece are shown somewhat separated from the connectors of the plasma generator in order better to illustrate the constituent parts.

FIG. 10 is a schematic longitudinal section through parts of an electrothermal-chemical weapon for firing an ammunition shot by means of the plasma generator according to FIG. 9.

FIG. 11 is a schematic cross section through parts of a plasma generator, in which is shown the corresponding half cross-section of the concentrically arranged combustion chamber, ceramic tube, sacrificial material tube and electrical conductors in the solidified plastic mass. The sacrificial material tube is also shown comprising a plurality of layers or, symbolically, the surface coatings which are burnt off, one for each energy pulse.

### DETAILED DESCRIPTION OF EMBODIMENTS OF THE INVENTION

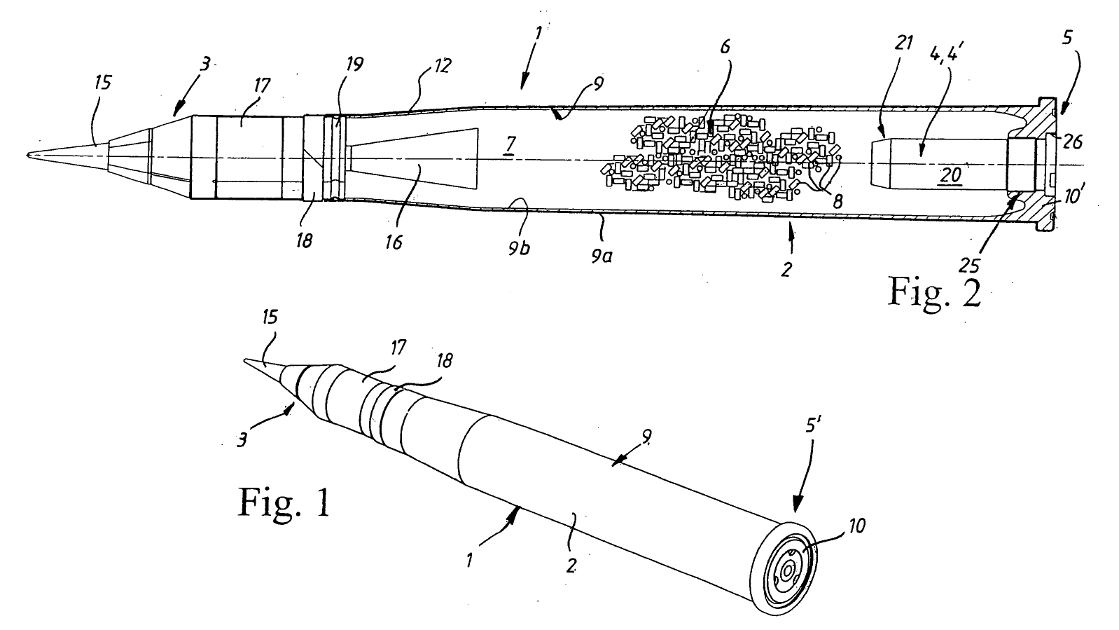

With reference to FIG. 1, a perspective view of an ammunition shot 1 for an electrothermal-chemical (ETC) weapon system, also hereinafter referred to as an ETC shot, is shown schematically, preferably comprising armor-piercing dart ammunition for use with, for example, tanks, combat vehicles and various anti-tank weapons, but also for use with, for example, fighter aircraft, anti-aircraft weapons and other artillery.

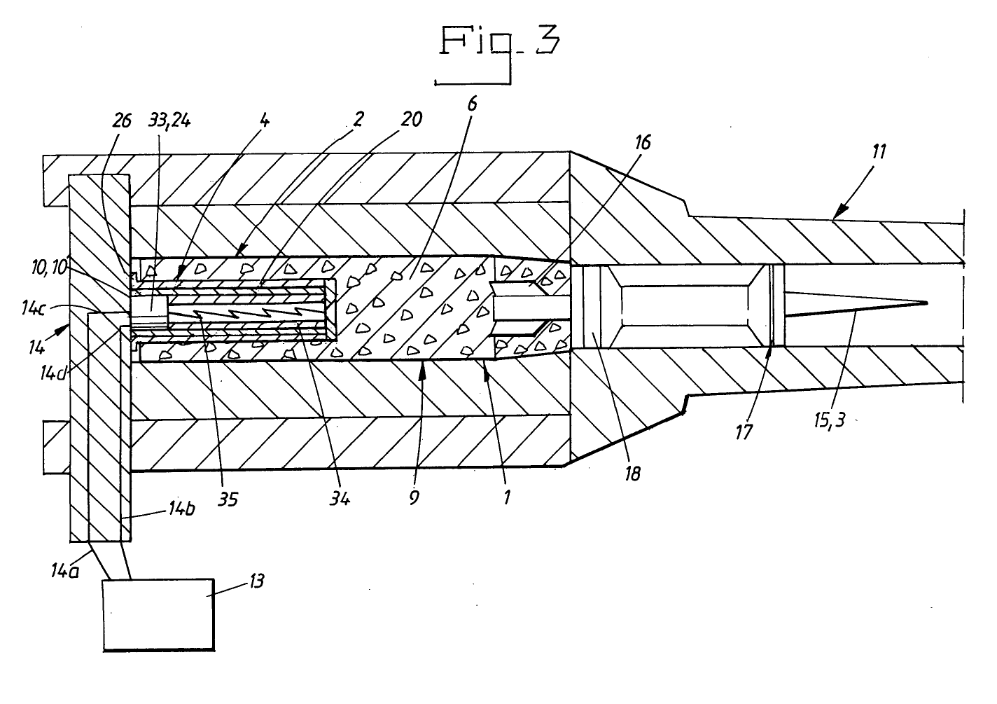

In FIG. 2 is shown a schematic longitudinal section through parts of a first embodiment of the ammunition shot 1 according to FIG. 1, which ammunition shot 1 comprises a cartridge case 2, a front projectile 3, a plasma generator 4, for forming a plasma disposed on the rear end 5 of the ammunition shot 1, and parts of a propellent charge 6 enclosed in the cartridge case 2. The propellent charge 6 is indicated only schematically in the middle of the cartridge case 2, but preferably the whole of the cavity 7 of the cartridge case 2 is filled with the propellent charge 6.

The propellent charge 6 is here comprised of granular gunpowder, also referred to as gunpowder pellets 8, for example a compacted NC gunpowder granular charge. Said gunpowder pellets 8 have often first been treated with a suitable chemical to produce an adhesion between the individual gunpowder pellets 8, whereafter the gunpowder pellets 8 are compressed into the propellent charge 6 desired for the particular cartridge case 2 and having a desired shape defined by the cavity 7.

The propellent charge 6 can also be comprised of a solid gunpowder (not shown) comprising at least one charge unit in the form of one or more cylindrical rods, disks, blocks etc., which charge units have been multiperforated with a greater number of burning channels, so that a so-called multipole gunpowder is obtained, and which charge unit or charge units together substantially hold, or fill, the internal dimensions of the cartridge case 2. Alternative embodiments of the propellent charge 6 also comprise multiperforated double-base (DB) gunpowder with inhibition, Fox 7, ADN, nitramine, GAP, etc. known gunpowder types, or a suitable liquid propellant (not shown).

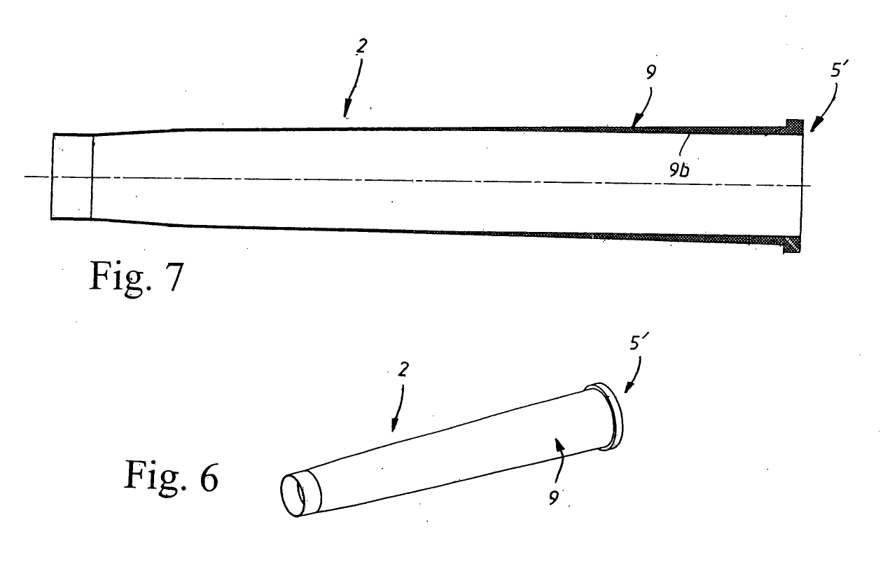

The casing 9 of the cartridge case 2, see FIGS. 2, 6 and 7, is preferably comprised of an electrically insulating material, i.e. dielectric or non-conductive, for example a fiber composite (see FIGS. 6 and 7), or else the casing 9 comprises a combination of different materials, in which at least one outer 9a and/or inner 9b coating or surface is electrically insulating (see FIG. 2).

In the embodiment of the cartridge case 2 which is shown in FIG. 2, this comprises a metallic casing 9 to which a plastic forming a thicker outer coating 9a and a thinner inner surface 9b has been applied for electrical insulation of, respectively, the outside and inside of the casing 9 in relation to at least the barrel 11 of the weapon system, see especially FIG. 3, and preferably also to the plasma generator 4. In the production of such a cartridge case 2, the casing 9 can be comprised, for example, of a conventional metal case, to which metal case a plastic is bonded by vaporization methods, whereupon an outer and/or inner protective plastic film coat with a thickness of about 20-70μ is formed. The thicker outer coating 9a can also be constituted by an outer shrinkable tubing 12, which has been placed over the casing 9, the outer dielectric coating 9a or directly on top of the propellent charge 6. In the embodiment shown in FIG. 2, the cartridge case 2 also comprises a bottom 10′, which is integrated with the rest of the casing 9 of the cartridge case 2, i.e. is made from and of the same material as the rest of the casing 9. It will be appreciated that said material can also be an inherently electrically insulating material.

In the embodiment of an electrically insulating casing 9 which is shown in FIGS. 6 and 7, this is here constituted by a rigid, wound, fiber-reinforced thermosetting plastic, for example by epoxy plastic, cured polyethylene, etc., having the outer shape of a cartridge case 2 intended for the particular weapon.

Following forming of the casing 9, this is ground to the desired thickness and a loose bottom piece 10 (see especially FIG. 1) is disposed at the rear end 5′ of the casing 9. Said bottom piece 10 is fastened to the rest of the casing 9 in a tight-fitting manner by means of threading, gluing or by means of some other joint (not shown in detail) appropriate to the function. The bottom piece 10 can therefore be unscrewable from the rest of the casing 9 or can be permanently fastened thereto. The bottom piece 10 can be made of a metallic material, which in that case is expediently insulated around its peripheral part via its fastening in the insulated casing 9 or via dielectric coating. Preferably, however, the bottom piece is made of the same insulating material as the electrically insulating casing 9.

When the ammunition shot 1 is used in the weapon system, said bottom piece 10 or bottom 10′ and the plasma generator 4 bear against the wedge, screw or back piece 14 of the weapon, see FIG. 3, whereby the plasma generator 4 is in electrical contact with a high-voltage source 13, the polarity of which can be shifted, via electrical connections 14a, 14b comprising connectors 14c, 14d in the form of input and output conductors disposed on the back piece 14 of the weapon system. Since the cartridge case 2, i.e. the casing 9 and preferably also the bottom piece 10 or the bottom 10′, apart from the actual plasma generator 4, comprises or is comprised of one or more materials which do not conduct current or voltage over to the barrel 11 and the wedge 14, there is no or only minimal risk of the cartridge case 2 burning and sticking fast in the particular weapon/gun due to an electrical short-circuit.

In one embodiment (not shown), it is also conceivable for the shrinkable tubing to be arranged directly on top of the propellent charge without an inner, rigid casing. The shrinkable tubing is here arranged such that it extends between the projectile and the bottom piece, with a rigidity necessary for the ammunition function, with the aid of the propellent charge and/or via vacuumization of the powder bag thus formed. Following firing of such an ammunition shot, in this embodiment only the metal bottom piece and/or plasma generator is left, the rest is burnt in the barrel.

In the embodiments of the ammunition shot 1 which are shown in the figures, see especially FIG. 2 and FIG. 3, the projectile 3 is comprised of a sub-caliber, fin-stabilized, armor-piercing dart 15 with guide cone or guide fins 16, which dart 15 is at least partially enclosed in and supported inside the casing 9 by a multipart dart-supporting body referred to as the sabot 17. Arranged around the sabot 17 is a girdle 18 for sealing the ammunition shot 1 against the inside of the barrel 11. A joint 19 in the form of, for example, grooving, see FIG. 2, gluing etc. connects the projectile 3 to the casing 9 of the cartridge case 2. Armor-piercing dart ammunition normally acquires its considerable effect from the fact that the dart 15, preferably, has an appreciable weight (density about 17-20 g/cm3, such as, for example, tungsten) and that it is fired at high velocity, so that the additional high velocity which is attainable with the present invention represents a major advantage.

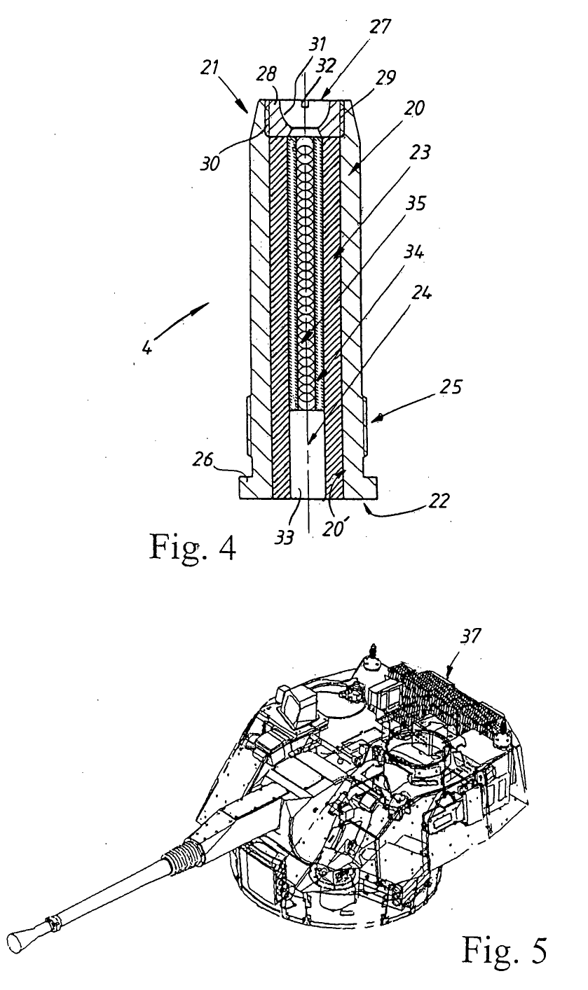

The plasma generator 4, in the embodiment shown in FIG. 4, which constitutes the equivalence of the ETC shot 1 to a conventional percussion primer, comprises an outer shell in the form of a tubular and electrically conductive, expediently metallic combustion chamber 20 having a front 21 and a rear 22 end, which outer shell, furthermore, is concentrically mounted inside the centric channel 20′ of the combustion chamber 20, which centric channel 20′, hereinafter also referred to as the combustion chamber channel 20′, passes axially through said combustion chamber from end to end 21, 22, an electrical and thermal insulation in the form of a dielectric, highly heat-resistant ceramic insert, ceramic coating or other ceramic unit, preferably a ceramic tube 23, and an innermost center electrode 24, which is disposed in the back of the centric channel 20′ and is enclosed by the ceramic tube 23. The ceramic tube 23 has a high temperature stability, i.e. is dimensioned to withstand very high temperatures, without cessation of its function, of up to a maximum peak temperature of at least about 50,000° K and an operating temperature of between about 10,000° and 30,000° K for at least the time for which the plasma is maintained or newly created via new energy pulses, and preferably for at least the whole of the time for which the projectile 3 is propelled through the barrel 11.

Said ceramic tube 23 is fitted inside the combustion chamber 20 via shrink-fitting, also referred to as shrink-fastening, i.e. by a heating and thus expansion of the metallic combustion chamber 20 and, possibly, a cooling and thus a slight shrinkage of the ceramic tube 23, whereby a sufficient tolerance is created between the combustion chamber 20 and the ceramic tube 23 to allow the ceramic tube 23 to be fitted inside the combustion chamber 20 in spite of the inner diameter of the combustion chamber 20 at normal temperature being less than the outer diameter of the ceramic tube 23. Following cooling of the combustion chamber 20 to the same temperature as the ceramic tube 23, the ceramic tube 23 enclosing the combustion chamber 20 will thus have contracted just enough that not only does the ceramic tube 23 sit quite tight along the whole of its outer surface against the inside of the combustion chamber channel 20′, so that the occurring clearances, formed by material irregularities and fault tolerances, between the ceramic and the walls of the combustion chamber channels are removed, possibly with a sealing compound or plastic material, for example metallic or ceramic, therebetween, which evens out all diameter variances, fault tolerances and irregularities and spreads the load, but also the ceramic tube 23 acquires a certain, precisely defined precompression through the shrinkage of the combustion chamber 20.

This precompression gives the ceramic tube 23 a strongly increased capacity to cope with the very high internal pressure, and thus the tensile stresses in the ceramic material which always arise during the plasma formation inside the combustion chamber channel 20′. The precompression of the ceramic tube 23 by the combustion chamber 20 is dimensioned such that the subsequent tensile stresses which arise in the ceramic during the plasma formation are less than the precompression, or are so much counteracted that the resulting stresses in the ceramic are lower than the maximally permitted tensile stresses for the ceramic. The ceramic tube 23 is expediently clamped in place with a clamping force of around 300 MPa-1000 MPa, preferably 500 MPa-700 MPa. The ceramic tube 23 comprises one or more ceramic materials, preferably titanium oxide, zirconium dioxide, aluminum oxide or silicon nitride or the like. The shrink-fitting and precompression of the ceramic tube 23 in the aforementioned manner also gives several other advantageous characteristics. In the shrink-fitting, the tolerance requirement between the constituent parts is less than in a direct fitting, where the fit must be extremely precise, which gives a considerably cheaper production of the plasma generator 4, in addition to which the otherwise inevitable empty space which would have to be present between the ceramic tube 23 and the combustion chamber 20 is eliminated. If the ceramic tube 23, due to a poor fit against the combustion chamber 20, were forced to alone bear the internal compressive loads imparted by the plasma, and the tensile stresses which would then arise in the ceramic material, the risk of fracture would increase dramatically, as ceramics normally have a considerably lower tensile strength than compressive strength.

The plasma generator 4 is either fixed to the bottom 10′ integrated with the casing 9 of the cartridge case 2, see FIG. 2, or to the bottom piece 10 arranged removably with the casing 9, see FIG. 1, which bottom 10′ or bottom piece 10 is preferably either made of dielectric material or else is coated with such material. For example, in the embodiment shown in FIG. 2, the combustion chamber 20 is arranged projecting from the rear end 5 of the cartridge case 2 and detachably fastened to the bottom 10′ by means of an external thread 25. The thread 25, see FIG. 4, is arranged in connection with the rear end 22 of the combustion chamber 20 and within a flange 26, i.e. in the direction of the front end 21, which flange is arranged there circumferentially and projects radially out from the combustion chamber 20. Preferably, the sole parts of the ammunition shot 1 behind the girdle of the projectile 3 which are in electrically conductive contact with the weapon are constituted by said flange 26 together with the metallic connector 33 of the center electrode 24, hereinafter referred to as the center connector. As the girdle 18, too, can be made of plastic, the ammunition shot 1 is very well electrically insulated. The flange 26 and the center connector 33 constitute the connectors of the combustion chamber 20 and of the center electrode 24 respectively, and comprise a respective end face 26a and 33a, which, when the ammunition shot 1 is used in the weapon system, is in electrical contact with, i.e. bears against, corresponding front end faces 48a and 49a of the second connectors 14c, 14d on the back piece 14.

The two connectors of the plasma generator 4, i.e. the flange 26 of the combustion chamber 20 and the connector 33 of the center electrode 24, which connectors 26, 33 are also referred to as the first connectors 26, 33, since they interact electrically with the two corresponding second connectors 14c, 14d on the back piece 14 by forming a respective connector pair consisting of, on the one hand, the connectors 26 of the combustion chamber 20, together with the output connector 14d of the back piece 14, and, on the other hand, the connector 33 of the center electrode 24, together with the input connector 14c of the back piece 14.

Upon use of the weapon system, the recoil of the weapon and other vibrations which occur can here cause an axial clearance Z to be formed between the rear end faces 26a and 33a of the first connectors 26, 33 on the plasma generator 4 and the front end faces 48a and 49a of the second connectors 14c, 14d on the back piece 14 of the weapon system, due to the fact that the plasma generator 4 and the back piece 14 are axially displaced relative to each other in the axial longitudinal extent Y of the combustion chamber 20. Said axial clearance Z is undesirable, since this can give rise to the formation of an electrical light arc between the rear 26a and 33a and the front 48a and 49a end faces, which short-circuits the plasma generator or welds together the end faces such that the weapon becomes unusable. In order to combat the risk of the end faces 26a, 33a, 48a, 49a being welded together, the connectors 14c, 14d of the back piece 14 can be configured with a rounded shape on their end faces 48a, 49a, such that the actual contact surface is reduced to a point or a sharp annular edge against the end face 33a of the center connector 33 or the annular end face 26a of the flange 26.

An orifice closure 27, see FIG. 4, in the form of a cylindrical body 28, acting as a front annular electrode interacting with the center electrode 24, is disposed in the combustion chamber channel 20′ at the front, somewhat beveled end 21 of the combustion chamber 4, axially outside and coaxially with the shrink-fitted ceramic tube 23 and the center electrode 24. The cylindrical body 28 comprises an external thread 29 for fitting of the orifice closure 27 to the combustion chamber channel 20′ provided with a corresponding internal thread 30. The orifice closure 27 further comprises a centric, nozzle-shaped end orifice opening 31 passing continuously through the cylindrical body 28, having a diameter which increases toward the front end 21 of the combustion chamber 20 to produce a plasma jet widening function toward the rear end of the propellent charge 6, and thus a better ignition and combustion of the propellent charge 6. Also shown is a groove 32 for a turning tool in the outer transverse surface of the cylindrical body 28, allowing the orifice closure 27 to be easily screwed to the front end 21 of the combustion chamber 20.

The center electrode 24 comprises the metallic, in the embodiment shown in FIG. 4, cylindrical center connector 33 for “input” electrical connection, which center connector 33 is fitted inside the rearmost part of the ceramic tube 23 via shrink-fitting (the center connector 33 is expediently cooled in nitrogen at −196° C., whereby a sufficient temperature difference arises relative to the ceramic tube 23 to allow shrink-fitting to take place), a sacrificial material 34 disposed between the center connector 33 and the orifice closure 27, expediently in the form of a tube, therefore also referred to as the sacrificial material tube 34, being fixed inside and against the inside of the ceramic tube 23, and at least one, but preferably a plurality of electrical conductors 35 being disposed inside the sacrificial material tube 34 and along the entire length of the sacrificial material tube 34, so that the center connector 33 and the cylindrical body are electrically connected to each other. The electrical conductor(s) 35, which act as a glow wire for facilitating the formation of a first electrical light arc between the center connector 33 and the orifice closure 27 or catalyst for the plasma formation, can expediently be comprised of thin wires, wool, rolled foil, mesh structures, porous thin films etc., preferably of metal, for example aluminum, copper, titanium or steel etc. Said fixing of the sacrificial material tube 34 to the ceramic tube 23 is expediently realized by means of a suitable permanent adhesive and by the fact that the sacrificial material tube 34 and the ceramic tube 23 acquire an axial fixing and certain clamping by virtue of the cylindrical body 28 being screwed to the end faces thereof with a certain set force. In order to ensure electrical contact, the threads 29, 30 can be copper-coated and the electrical conductor(s) 35 can be clamped in said threads 29, 30. As a result of the aforementioned measures, the sensitivity of the plasma generator 4 to shocks and vibrations is also broadly successfully eliminated.

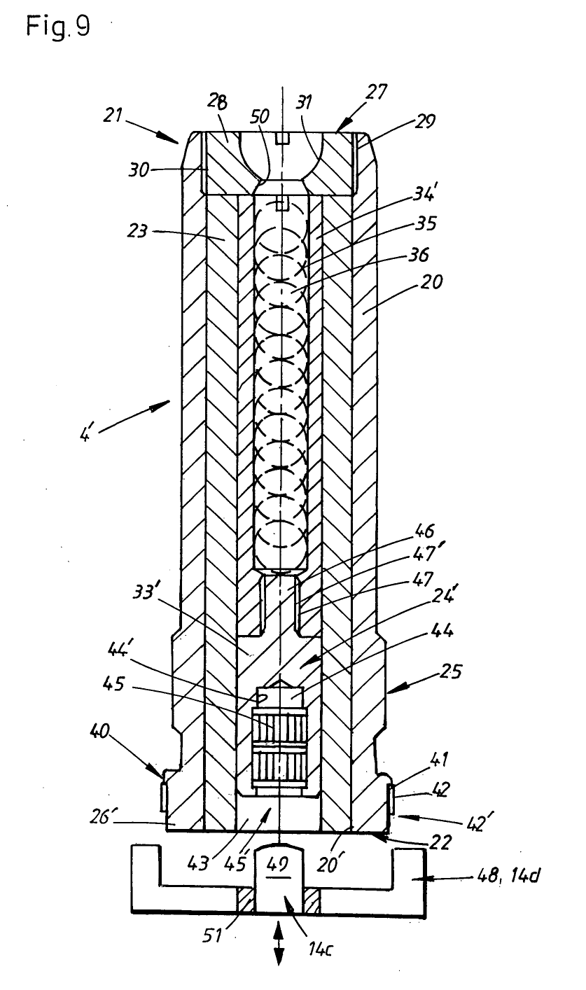

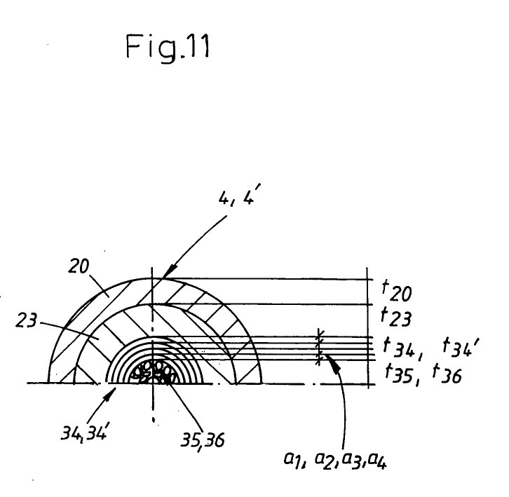

The sacrificial material tube 34 with total thickness t₃₄, t_{34′}, see especially FIG. 11, in which the sacrificial material tube for different components is denoted without ′ for the first embodiment shown in FIG. 4 but with ′ for the second embodiment shown in FIG. 9, is intended, in a coating-by-coating combustion of the same, to be gasified to the extent of one layer or surface coating a1, a2, a3, a4 for each new energy pulse and to release above-explained “lighter” molecules, atoms or ions, which generate a plasma and which facilitate the ignition and the combustion of the propellent charge 6 and maintain and enable the continued plasma process even after the electrical conductors 35 have been consumed.

FIG. 11 thus shows a schematic sacrificial material tube 34, 34′, having a certain total thickness t₃₄, t_{34′}, in which the total tube thickness t₃₄, t₃₄′ is shown divided into a number (here, in the specifically shown embodiments, four) of concentric, theoretical surface coatings or actual layers laminated one on top of the other, labeled jointly for both with a₁, a₂, a₃, a₄. The number of schematically shown surface coatings or layers a₁, a₂, a₃, a₄ in FIG. 11 represents, as explained in greater detail below, either the number of surface coatings which are gasified by the same number of fired energy pulses (in which each of the shown surface coatings also represents the surface coating thickness which is gasified for the respective delivered energy pulse, which delivered energy pulse, and thus also the surface coating thickness belonging thereto, can vary), or the number of actual layers and their thickness which have been predimensioned and have subsequently been combined into an estimated or calculated consumption requirement per delivered energy pulse for a certain type of ammunition shot and ETC weapon.

The total thickness t₃₄, t₃₄′ of the sacrificial material 34, 34′, its separate part-thicknesses a₁, a₂, a₃, a₄ and its constituent material choice are therefore precisely dimensioned and selected in order that a thinner surface coating or layer a₁, a₂, a₃, a₄ will always be able to be gasified per delivered electrical energy pulse, whereupon said sacrificial material 34, 34′ is heated, gasified and ionized coating-by-coating or layer-by-layer a₁, a₂, a₃, a₄ into plasma via the very powerful, electrical energy pulse triggered with a set term, amplitude and shape between the center electrode 24, 24′ and the annular electrode, i.e. the orifice closure 27, for each such surface coating or layer a₁, a₂, a₃, a₄, a predetermined plasma being made to flow out through the end orifice opening 31 with a very high pressure and at a very high temperature, preferably between about 10,000° K and 30,000° K.

The term ‘lighter molecules and atoms’ denotes, here, molecules and atoms with low molecular weight, preferably ≦u (30 g/mol), from material which, upon combustion, forms molecules and ions which are lighter, i.e. have a lower molecular weight, than the molecules and ions which are formed by the particular electrical conductor(s) 35 and the heavier metal ions ablated from the combustion chamber channel walls in the known plasma generators, and, preferably, from the combustion of the propellent charge 6. One aim of this is that the ionization shall produce electrically charged molecules and/or atoms, which give an improved ignition of the propellent charge 6, and that the formed plasma shall acquire a considerably lower acoustic velocity than that boasted by the conventional propellent gases, thereby producing an advantageous accelerating effect upon the projectile 3.

The sacrificial material tube 34, 34′ therefore comprises at least one sacrificial material, which at least in the formed plasma disintegrates into molecules, atoms or ions in which the sum of the atomic masses for the atoms in the disintegrated molecule (the molecular mass) is preferably lower than about 30 u (g/mol). Such a sacrificial material 34, 34′ expediently contains, for example, hydrogen and carbon, which comfortably meet this condition. The sacrificial material tube 34, 34′ in the embodiments described here in FIG. 4 and FIG. 9 is comprised of at least one dielectric polymer material, preferably a plastic with high melt temperature (preferably over 150° C.), high gasification temperature (over 550° C., preferably over 800° C.) and low thermal conductivity (preferably below 0.3 W/mK). Especially suitable plastics comprise thermoplastics or thermosetting plastics, for example polyethylene, fluoroplastic (such as polytetrafluoroethylene, etc.), polypropylene etc., or polyester, epoxy or polyimides etc., to provide that only one surface coating or layer a₁, a₂, a₃, a₄ of the sacrificial material is gasified for each energy pulse. The sacrificial material 34, 34′ should, preferably, also be sublimating, i.e. pass directly from solid form to gaseous form. It is also conceivable to arrange different layers of material, thickness etc. to form a laminated sacrificial material tube in order to achieve said coating-by-coating a₁, a₂, a₃, a₄ gasification of the laminate.

The thickness t₃₄, t_{34′} of the sacrificial material tube 34, 34′ is calculated, dimensioned and produced such that only the outermost free surface coating or layer a₁, a₂, a₃, a₄, i.e. that facing out from the surface of the ceramic tube 23 toward the electrical conductors 35, is gasified with each electrical pulse, whereby a plurality of pulses can be generated from the plasma generator 4, 4′ into the cartridge case 2 and onward to the barrel 11, whereupon additional plasma, and thus electrical energy, can be supplied after the first-delivered plasma (see the functional description for greater clarification). Even if the plasma is allowed to cool between the energy pulses, the plasma generator 4, 4′ can still be fired and deliver new light molecules as long as the sacrificial material 34, 34′ remains. It is here worth noting that the ceramic tube 23 prevents the metallic combustion chamber channel 20′ from releasing ions, so that those plasma generators which comprise a ceramic lining utilize a metal wire or an electrically conductive material to initiate the light arc between the electrodes, and once this wire/material has burnt up and the plasma has died down/squirted out of the plasma generator, no new energy pulse can be fired. Optimally, the sacrificial material 34, 34′ must not be consumed until the last electrical energy pulse which is required to be generated to the plasma in order to produce the desired pressure curve inside the barrel 11 is delivered, whereupon the projectile 3 receives its last energy boost, and thus the last increase in pressure and the last increase in acceleration, at the same time as the projectile 3 leaves the barrel muzzle.

By virtue of the fact that the sacrificial material 34, 34′ has such a high gasification temperature and such a low thermal conductivity and the chosen sacrificial material 34, 34′ manages, despite considerably longer pulse length, to be gasified coating-by-coating, or layer-by-layer a₁, a₂, a₃, a₄, for each new electrical energy pulse, a satisfactory solution to the problems of attaining the desired considerably longer pulse lengths, i.e. pulse lengths longer than 3-10 milliseconds, and the sought-after, appreciably extended plasma life is obtained without the onset of such high temperatures that the plasma generator 4, 4′ is damaged in spite of the ceramic lining/the insert. The fact that the sacrificial material 34, 34′ manages to be gasified only to the extent of one surface coating/layer a₁, a₂, a₃, a₄ for each new energy pulse means that the sought-after, considerably extended plasma life is obtained and the temperature which would otherwise be harmful to the plasma generator 4, 4′ is cooled by the continuous supply of light ions.

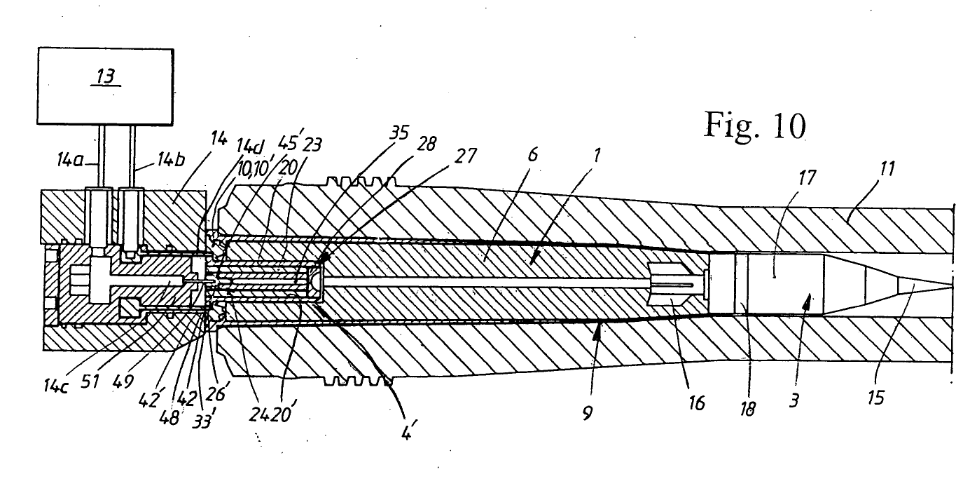

The plasma formation from the dielectric sacrificial material 34, 34′ and the electrical energy supply for the propulsion of the projectile 3 continue throughout the propulsion process by virtue of the fact that the high-voltage source 13 (see especially FIG. 3 and FIG. 10) applies an electrical potential over the dielectric sacrificial material 34, 34′ via (see especially FIG. 4 and FIG. 9) electrodes 28, 33, 33′, i.e. the cylindrical body 28 and the center connector 33, 33′, at opposite ends of the combustion chamber channel 20′. The total propulsion energy for the projectile 3 therefore receives a substantial energy boost via the supply of extra electrical energy from the high-voltage source 13 via the plasma formed inside the combustion chamber 20. The quantity of plasma which squirts into the cartridge case 2 joins with the ionized propellent charge gases, so that the total quantity of plasma out in the barrel 11 increases in line with the acceleration of the projectile through the whole of the barrel 11, right until the projectile 3 leaves the barrel 11, so that the gas pressure is maintained at the desired barrel pressure throughout this process.

Should a closed electrical circuit be provided between the connectors 33, 33′ of the center electrode 24, 24′ and an electrode further forward in the barrel 11, then additional energy can be supplied to a plasma there (not shown).

When the invention is used in a combat vehicle, the high-voltage source 13 is expediently applied as comprising an “intermediate store” on the turret, such as a pulse unit 37 in the form of a “rucksack”, see FIG. 5, which is charged in the face of a volley of shots from a “main store” disposed inside the actual combat vehicle.

In the second embodiment of the plasma generator 4′ according to the invention, which is shown in FIG. 9, this second embodiment has substantially all the same components, material choices, characteristics, inclusive of possible combinations thereof, as the first embodiment of the plasma generator 4 which is shown in FIG. 4 and is described in the above text, so that the same reference numerals are used wherever possible below.

The essential differences which are shown in the embodiment according to FIG. 9, and which have in this case received the reference numeral labeled with ′, are, for example, that the metallic combustion chamber has an improved configuration of the flange 26′, which improved flange 26′, along its peripheral, radial circumferential rim 40, now comprises a groove 41, wherein which groove 41 an outer, enclosing lamellar contact strip 42 of conductive material, for example copper, is disposed, for example glued, or otherwise fixed in the groove 41. This unique construction, here comprising the peripheral, radial circumferential rim 40 with the groove 41 and the outer lamellar contact strip 42, is hereinafter referred to, for the sake of simplicity, also as the outer lamellar contact 42″.

The outer, enclosing, lamellar contact strip 42, which is somewhat arched in its cross section and is fitted with its convex side outward, comprises, in relation to its longitudinal extent, transverse, evenly distributed, continuous, leak-tight gaps for the realization of thin, bridge-shaped lamellae with elastic characteristics for the establishment of a good contact, and thus also a reliable electrical contact surface, against the sliding surface 53 of a therewith interacting female connector 48, shown in FIG. 9 and FIG. 10, disposed in the back piece 14 and acting as the output conductor 14d of the back piece 14, in which female connector 48 the flange 26′ is inserted by a certain set distance, preferably exceeding the flange thickness. Correspondingly, the bottom 10′ or the bottom piece 10 comprises a circular groove 48a, see FIG. 10, for the annular edge on the output conductor 14d, i.e. the connector 48, which circular groove has a depth corresponding preferably to at least the thickness of the flange 26′. The effect of this is that the flange 26′ with the lamellar contact strip 42 and the female connector 48 can move, i.e. be axially displaced, by a shorter distance relative to each other, with a maintained sliding contact between them corresponding to at least the expected axial clearance Z, caused, for example, by the recoil(s) and other vibrations which arise during use of the weapon.

The plasma generator 4′ according to this second embodiment, FIG. 9, further comprises a somewhat differently configured center electrode 24′. The rear metallic center connector 33′ is in FIG. 9 shown somewhat axially displaced inside the ceramic tube 23 in the direction of the front cylindrical body 28, with the formation of an empty space 43 toward the rear end 22 of the combustion chamber 20, which empty space 43 is intended for the male connector 49 of the back piece 14, i.e. its input conductor 14c (schematically shown in FIG. 9 and FIG. 10), which connector 49 has a length which expediently exceeds the flange thickness, preferably has double the thickness of the flange 26′ in order to ensure a large sliding surface 52 along the radial contact surface of the male connector 49. In addition, said center connector 33′ comprises a rear centric cavity 44 extending axially inward, the inner surface 44′ of which cavity 44 is lined with the same type of lamellar contact strip 45, and with corresponding function, as the lamellar contact strip 42 of the flange 26′, yet with the difference that the male connector 49 disposed on the back piece 14, which is schematically shown in FIG. 9 and FIG. 10 and acts as the input conductor 14c, is inserted therein. Here too, in the same way as above, this unique construction, comprising at least the rear centric cavity 44 and the lamellar contact strip 45, but expediently also the empty space 43, is referred to for the sake of simplicity also as the inner lamellar contact 45″ in this text.

The center connector 33′ in the second embodiment shown in FIG. 9 also comprises a front, threaded pin 46, on which pin 46 the sacrificial material 34′ is threaded by means of a corresponding recess 47 with internal thread 47′. A better securement of the sacrificial material 34′ inside the combustion chamber channel 20′ is then achieved, since any of the plasma jets flowing out of the combustion chamber 20 is otherwise at risk of “blowing” out the sacrificial material 34′ content of the combustion chamber 20. For this reason, the sacrificial material 34′ is additionally glued to the inside of the combustion chamber channel 20′ and is arranged in such a way in relation to the cylindrical body 28 that this body 28 acts as a counterstay for the sacrificial material 34′ and the ceramic tube 23. In the shown second embodiment, the electrical conductors 35 can be inserted in the thread 47′ between the pin 46 and the recess 47, the electrical conductors 35 being held fixed inside the sacrificial material tube 34′. The electrical conductors 35 can additionally be fixed by means of a solidified plastic mass 36, which is most simply poured molten into the sacrificial material tube 34′ and thus encloses the electrical conductors 35 within itself. The sacrificial material tube 34′ can also similarly be poured molten into the ceramic tube 23, solidified around the threaded pin 46 and subsequently bored out for application of the electrical conductors 35 and the solidified plastic mass 36. In the case of a plurality of material layers, this process is repeated such that the desired laminate materializes. All said fixings of said components serve to make the plasma generator 4′ very vibration-proof, which has proved a major problem in previously known plasma generator constructions. The solidified plastic mass 36 can be comprised, for example, of stearine, paraffin, glycerine, gelatine etc.

Said mutually insulated 51 male 49 and female 48 connectors of the back piece 14 (shown only schematically in FIGS. 9 and 10), or the flange 26′ arranged on the plasma generator 4′, comprising the outer, enclosing lamellar contact strip 42, and the center connector 33′, comprising the rear centric cavity 44 and the inner lamellar contact strip 45, which is fixed there, in similar fashion as for the outer lamellar contact strip 42, against the radial inner surface 44′ of the cavity 44, thus act as the connectors of the weapon system in the form of input and output conductors 14c, 14d, having a comparably larger contact surface than in previous constructions, which new input and output conductors 14c, 14d cope better firstly with normally occurring vibrations, secondly with a relatively large recoil of the weapon, and thirdly with the motions(s) generated with the energy pulse, and thus a minor axial displacement of the connectors 48, 49 of the wedge/the back piece 14 in relation to the outer and inner lamellar contacts 42″, 45″ of the plasma generator 4′ on the flange 26′ and the center connector 33′, i.e. on its outer and inner lamellar contact strips 42, 45, without the bearing contact and thus the electrical contact being worsened with the recoil, or with other occurring vibration or shock, which worsened contact can be the case where constructions are used which only have contacts of the point-contact or surface-contact type.

The connector 42′ on the combustion chamber 20 and the connector 45′ on the center electrode 24′, constituting two first connectors 42′, 45′ on the plasma generator 4′, electrically interact with a respective connector 48, 49 each on the back piece 14, constituting two second connectors 48, during the axial displacement, by each one of the first connectors 42′, 45′ forming a connector groove 42′, 48 and 45′, 49 with each one of the second connectors 48, 49.

In such contacts of the point-contact or surface-contact type, the connectors in each connector pair, which rest one against the other, are at risk of being somewhat separated from each other firstly upon the movements of the weapon, and secondly upon the firing of each energy pulse, whereupon said small axial clearance Z can arise between the rear end face 26a and 33a of each of the two first connectors 42′, 45′ on the plasma generator 4′ and each front end face 48a and 49a of the two second connectors 48, 49 on the back piece 14, which then produces an electrical light arc which threatens to weld the connectors together, especially in the event of particularly high energy transfers. If this welding of the connectors were to occur, it would become impossible for a new ammunition shot to be placed in firing position in the wedge, the back piece etc. In a weapon of this type, it can therefore be difficult to automatically shoot a number of successive ammunition shots over a lengthy period without the weapon seizing up. Even in the case of just one singular energy pulse, the connectors can burn and stick fast if the contact surface is too small and the energy transfer is too large. In the case of large energy transfers, the second embodiment shown in FIG. 9 therefore copes better than the first embodiment shown in FIG. 4, so that the connectors of the first embodiment belonging to the plasma generator 4, and the back piece 14 interacting with the latter, are expediently given a somewhat rounded contact surface shape (not shown), whereby the capacity to perform large energy transfers without major risk of welding is improved.

In the second embodiment shown in FIG. 9, having the unique configuration of the center connector 33′ and of the flange 26′, comprising the so-called lamellar contacts 42″, 45″ having the lamellar contact strips 42, 45 mounted in the groove 41 and the inner surface 44″ of the rear centric cavity 44, it is possible to automatically shoot a number of successive ammunition shots 1 and also to fire a number of pulses for each such ammunition shot 1 without the axial clearance and the ensuing light arc materializing between the connectors 48, 49 or the lamellar contacts 42″, 45″ of the back piece 14 and of the plasma generator 4′, which light arc would otherwise normally cause the connectors 48, 49 to threaten to weld together, since the lamellar contacts 42″, 45″, in interaction with the connectors 48, 49, cope easily with normal external vibrations and with the recoil, as well as with the other vibrations which arise in the particular barrel weapons during use of the plasma generator 4′.

One difference with the configuration of the lamellar contacts 42″, 45″ which is shown in FIG. 9 compared with the first embodiment shown in FIG. 4 is that the first connectors 42′, 45′ on the plasma generator 4′, i.e. the outer and inner lamellar contact strips 42, 45 in FIG. 9, provide the facility for the connectors 48, 49 and the lamellar contact strips 42, 45 to be able to slide relative to each other over a certain axial distance, so that said axial clearance Z is formed, and yet be in unbroken radial contact by virtue of the sliding surface 52, 53, interacting between them, of the respective part. This configuration of the contact surface naturally provides a considerably larger contact surface than is the case with the customary contact surfaces of the point-contact or surface-contact type, so that the current transfer is spread over this larger contact surface, so that the current transfer is facilitated and the risk of a light arc is eliminated, thereby preventing welding/burning fast even in the event of a number of pulses.

Functional Description

The production, working and use of the plasma generator 4, 4′ according to the invention is as follows. Compare FIG. 3 and FIG. 4 for the aforementioned first embodiment and FIG. 9 and FIG. 10 in respect of the second described embodiment.

In order to fit the ceramic tube 23 inside the metallic combustion chamber 20, the combustion chamber 20 is first heated to about 550° C., whereafter the ceramic tube 23, which can be cooled, yet not so much that it gets split, is thrust into the combustion chamber channel 20′. When the combustion chamber 20 and the ceramic tube 23 have reached the same temperature, the combustion chamber 20 will have shrunk more than the outer diameter of the ceramic tube 23 at this temperature, so that the ceramic tube 23 is precompressed by the combustion chamber 20. The greater the diameter difference between the outer diameter of the ceramic tube 23 and the diameter of the combustion chamber channel 20′, the greater the precompression. The desired precompression in the ceramic tube 23 can thus both be calculated and obtained.

The center connector 33, 33′ (expediently cooled in nitrogen to −196° C.) is similarly fitted inside the ceramic tube 23 and, following return to normal temperature, the center connector 33, 33′ has expanded so much that it sits securely fixed inside the ceramic tube 23.

The sacrificial material 34, 34′ is applied either by being glued in the form of a tube, or by being poured in liquid state down into the ceramic tube 23, whereafter the sacrificial material 34, 34′ is expediently bored for reception of the electrical conductors 35, which are expediently wedged in the thread 29, 30 when the cylindrical body 28 is screwed in place. A highly vibration-proof plasma generator has thus been obtained. In the second embodiment, shown in FIG. 9, this has been further improved by an adhesive-coated sacrificial material tube 34′ being inserted inside the ceramic tube 23 and screwed onto the threaded pin 46. The electrical conductors 35 are expediently wedged in the thread 47′ when the center connector 33′ is screwed onto the threaded pin 46. The sacrificial material tube 34, 34′ is expediently locked in place by the cylindrical body 28, since the nozzle opening 50 of the cylindrical body 28, facing the combustion chamber 20, is smaller than the diameter of the sacrificial material tube 34, 34′. The lamellar contact strips 42, 45 are then fixed firstly in the radial groove 41 of the flange 26′, and secondly on the radial inner surface 44′, which in the same way as the groove 41 of the flange 26′ can be configured with a radial groove for the inner lamellar contact strip 45, inside the rear centric cavity 44 in the center connector 33′. Following screwing of the plasma generator 4′ to the bottom 10′ or bottom piece 10 of the cartridge case 2, an ammunition shot 1 is obtained which is ready for firing and can be loaded into the particular ETC weapon. It will be appreciated that the plasma generator 4, 4′ according to the invention can also be applied in a cartridge-less shot, i.e. where powder bags and projectile are arranged directly in the barrel without a cartridge case, for example only enclosed in the aforementioned shrinkable tubing 12.

Upon firing of an ammunition shot 1, see FIG. 3 and FIG. 10, situated in the wedge/screw piece/back piece of the particular weapon system, the high-voltage source 13 is connected solely via the input and output conductors 14c, 14d of the electrical connections 14a, 14b, i.e. via the connectors 48, 49 of the back piece 14 and, on the one hand, in the first embodiment shown in FIG. 3 and FIG. 4, the connector 33 of the center electrode 24 and the flange 26 of the combustion chamber 20, and on the other hand, in the second embodiment shown in FIG. 9 and FIG. 10, the lamellar contact 42″ of the flange 26′ and the lamellar contact 45″ of the center connector 33′.

Other weapon parts are expediently precisely insulated from all contact with the plasma generator 4, 4′. All unwanted impartation of current to the weapon is therefore effectively prevented. The center connector 33, 33′ and the orifice closure 27 act as an anode and a cathode respectively, which are disposed on opposite ends of the combustion chamber channel 20′ and which are electrically connected to each other via the electrical conductor(s) 35 between them. The transfer of electricity occurs only via the rear end 22 of the plasma generator 4, 4′.

The current/voltage follows the easiest path through the plasma generator 4, 4′, i.e. initially from the connector 49 in the form of the input conductor 14c and, in the first embodiment in FIG. 3 and FIG. 4, the connector 33 of the center electrode 24, or, in the second embodiment in FIG. 9 and FIG. 10, the inner lamellar contact 45″ comprising the rear centric cavity 44 and the lamellar contact strip 45, via the electrical conductors 35 to the cylindrical body, i.e. the annular electrode 28, and then, following combustion of the electrical conductors 35, via the formed, extremely hot plasma, which plasma has very high electrical conductivity due to the ionization of the molecules and the atoms, which molecules, atoms and ions are formed in the gasification of the combustible parts incorporated in the center electrode 24, 24′, i.e. the sacrificial material tube 34, 34′ and the electrical conductors 35, whereafter the current/voltage is fed back toward the bottom 10′ or bottom piece 10 of the cartridge case 2 via the outer shell of the metallic combustion chamber 20 to, for the first embodiment in FIG. 3 and FIG. 4, the flange 26 on the back part 22 of the combustion chamber 20 and the electrical connector, in the form of the output conductor 14d, disposed there, or, in the second embodiment in FIG. 9 and FIG. 10, the outer lamellar contact 42″, comprising the peripheral circumferential rim 40 with the radial groove 41 and the outer lamellar contact strip 42 for the annular connector 48 on the back piece 14. As a result of the described construction of the plasma generator 4, 4′, a closed container for the plasma is obtained until the plasma jet is formed, which prevents short-circuiting of the process. Said feedback of the electricity is also facilitated, of course, if the cartridge case 2, and preferably also the bottom 10′ or the bottom piece 10, comprises or is comprised of an electrically insulating material, such as said fiberglass-reinforced winding epoxy or plastic film coating. The barrel 11 is therefore not live, at the same time as the risk of flash-over/short-circuiting will be very substantially reduced or wholly eliminated.

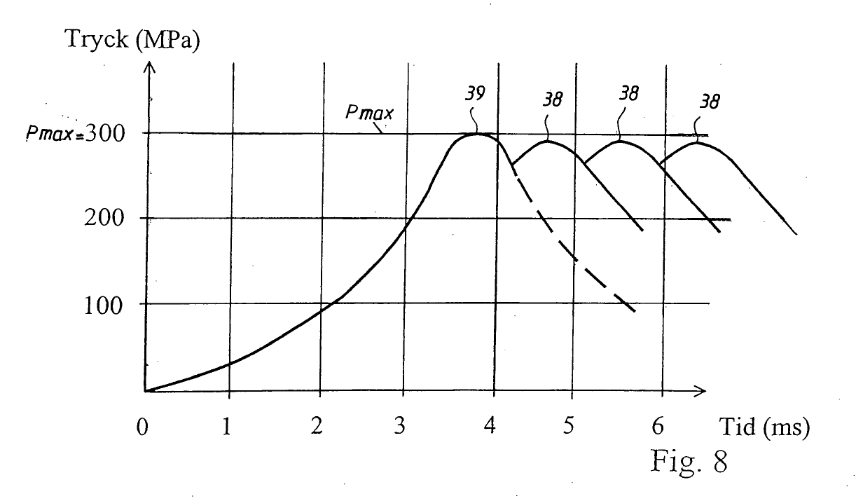

Upon the firing, the high-voltage source 13, for example said pulse unit 37 (FIG. 5), is made to deliver at least one powerful electrical energy pulse, though preferably a plurality of electrical energy pulses comprising a high current intensity and/or a high voltage, both with a certain set amplitude and length geared to the characteristics applicable to the particular weapon, the shot, the target, the environment, etc. In order to produce an effective plasma, in, for example, a medium-caliber weapon (40 mm), each energy pulse should exceed 10 kJ and be supplied to the plasma with a pulse length of around one or a few milliseconds (see especially FIG. 8).

Where a pulse unit is used, this comprises capacitors for delivering voltage of about 5-50 kVolt. The current intensity can amount to between 5 and 100 kA, in future even above 100 kA, so that it will be appreciated that the risk of personal injury is high in the event of an unwanted flash-over with current and voltage being imparted to the barrel 11.

The powerful energy pulse(s), preferably about 1-6 energy pulses, heat the electrical conductor(s) 35 to such a high temperature that they melt, are gasified and are finally ionized in a light arc into a very hot first plasma, which thus initially comprises essentially only heavier metal ions from said electrical conductor(s) 35. The heat from this first plasma gasifies and then, in turn, ionizes an outermost surface coating/layer of the sacrificial material tube 34, 34′, so that the ions and molecules of this surface coating/layer are mixed with the first plasma to form a second, mixed plasma comprising also lighter ions and molecules, and which second plasma, due to the high pressure which is built up inside the ceramic tube 23 and the sacrificial material tube 34, 34′ during the ionization by means of the regularly or intermittently sent energy pulses, is made to squirt out through the end orifice opening 31 in the cylindrical body 28 into the cartridge case 2, in the form of a plasma jet. The interval between the energy pulses, the pulse length, the current intensity, the voltage and the energy boost can be varied according to the particular conditions at the moment of firing, such as ambient temperature, air humidity, etc., and for the specific characteristics of the present weapon system and ammunition type—or projectile type, as well as the particular target type, inclusive of the distance to said target.

One aim of the sacrificial material tube 34, 34′ is thus that this, in the ionization, shall release electrically charged and therefore electrically conductive particles, compounds, molecules and/or atoms, i.e. ions, which are lighter than those which are obtained in the ionization of the electrical conductors 35, so that, inter alia, an improved ignition of the propellent charge 6 is obtained. With the aid of the plasma generator method which is shown here, it is thus possible to produce a temporally exact ignition of the ammunition shot. It is also possible to temperature-compensate the whole or parts of the pressure deterioration which is obtained when a colder ambient temperature than normal is experienced, and also to reduce the safety margin for a pressure maximum in the dimensioning of the barrel.

The fact that the surface coatings or layers a1, a2, a3, a4 of the sacrificial material tube 34, 34′ release molecules, atoms and ions which are lighter than the heavier metal ions which are formed from the electrical conductors 35 and that the advantageous characteristics of the particular plasma are substantially maintained between the energy pulses, since there is no time to die down or fade to a level which is unfavorable for the ignition and combustion of the propellent charge, gives rise to the aforementioned advantages. In addition, the separate electrical energy pulses will act upon the electrical conductors 35, the inner sacrificial material tube 34, 34′ and the formed plasma in steps. For example, the first energy pulse can produce a gasification and ionization of at least the electrical conductor(s) 35, preferably also a first surface coating/layer al from the sacrificial material tube 34, 34′, and an ignition inclusive of commenced gasification of the propellent charge 6 and an ionization of the thereby formed propellent gases, whereafter the following electrical energy pulses, in turn, can gasify and ionize further thin surface coatings/layers a2, a3, a4 of the sacrificial material tube 34, 34′, as well as maintain the already formed plasma and a continued ionization into plasma of the newly formed propellent gas quantities from the progressive combustion of the propellent charge 6 throughout the propulsion through the barrel 11, with no occurrence of an electrical short-circuiting or a reversion from plasma to gaseous form. The plasma, due to its electrical conductivity, is supplied with the desired quantity of electrical energy, which supply is effected via one or more electrical pulses with set wave form and durability, whereby the barrel pressure is maintained at the level optimal for the particular firing throughout the propulsion of the projectile 3 through the whole of the length of the barrel.

This is due to the fact, inter alia, that the propellent charge 6 is burnt much more effectively by the pulsed plasma jet, extra energy is supplied etc., as has been explained above. One or more further pressure increases 38, see FIG. 8, will be obtained, one for each additional energy pulse, in addition to the pressure maximum 39, in FIG. 8 300 MPa is shown as an example of Pₘₐₓ which is obtained in a comparable conventional ignition. When an ammunition shot 1 is fired, the individual pressure curves 38, 39 from each of the imparted electrical pulses mutually overlap, such that the total pressure curve which is obtained for the particular barrel 11 is always just less than the permitted maximum pressure of the barrel, at the same time as the pressure troughs of the total pressure curve are minimized.

Two principal ways exist of executing the coating-by-coating, or layer-by-layer a1, a2, a3, a4, burning-off of the sacrificial material.

Firstly, the coating-by-coating a1, a2, a3, a4 burning-off can be realized on the basis of the energy boost if required, and which in this case is expediently detected via suitable sensors, at the moment of the energy pulse, in order to compensate for the particular pressure reduction in the barrel at said moment. The gasified surface coating thickness a1, a2, a3, a4 then corresponds to the required energy boost for getting back up to Pₘₐₓ.

The second implementation is, on the basis of weapon, ammunition type, target etc., to previously build up the sacrificial material in defined layers a1, a2, a3, a4 with respect to material and desired characteristics, so that each such layer a1, a2, a3, a4, given an individualized energy pulse at a certain predefined pulse interval, provides the desired energy boost for the maintenance of Pₘₐₓ, i.e. the thicknesses of the layers a1, a2, a3, a4 are determined at the time of the energy pulses fired at a certain interval, so that a pre-estimated pressure increase to Pₘₐₓ is achieved.

Illustrative Embodiments

In varying illustrative embodiments of a plasma generator according to the invention, intended for a 40 mm ammunition shot, ceramic tubes having an outer diameter of about 14-20 mm and a tube thickness of about 2-6 mm are used, as well as sacrificial material tubes of various polymer materials and thicknesses, which are disposed in these ceramic tubes. Said sacrificial material tubes were here specifically dimensioned to thicknesses of about 1-6 mm, whereby a coating-by-coating gasification of the sacrificial material tube was achieved during a number of successively fired energy pulses of about 10-100 kJ with a length of around one to a few milliseconds per pulse and with a voltage of up to about 50 kVolt. The current intensity was normally between 5 and 100 kA, but above 100 kA is also conceivable, and a barrel pressure of about 400-500 MPa was attained, which was maintained substantially continuously throughout the propulsion process.

Alternative Embodiments

The invention is not limited to the specifically shown embodiments, but can be variously modified within the scope of the patent claims.

It will be appreciated, for example, that the number, size, material and shape of the elements and components which make up the ammunition shot and the plasma generator are geared to the weapon system(s) and other design characteristics obtaining at the time.

It will be appreciated that the above-described ETC ammunition can comprise a number of different dimensions and projectile types depending on the field of application and the barrel width. Here above, however, allusion is made to at least the currently most common ammunition types of between about 25 mm and 160 mm.

In the above-described embodiments, the plasma generator comprises only a front opening for a plasma jet, but it falls within the inventive concept to provide more such openings along the surface of the combustion chamber.

In addition to the electrically insulated cartridge case, it is conceivable to also provide an additional insulation of the actual plasma generator by means of a non-conductive material applied to the outside of the combustion chamber.

The above-described invention can also be configured for possible use to shoot automatic fire, both with respect to the plasma generator configuration with two separate connectors/surfaces for direct electrical connection of each individual ammunition shot to the particular weapon system via its back piece and there-disposed corresponding connectors/surfaces in the wedge of the back piece, i.e. the wedge which acts as a counterstay when the shot is fired and which bears directly against the bottom of the ammunition shot in the wedge.

1. A plasma generator for electrothermal and electrothermal-chemical weapon systems, which plasma generator comprises a combustion chamber (20) having a combustion chamber channel, and a center electrode disposed inside the combustion chamber channel, which combustion chamber and center electrode are electrically conductive and each comprise a respective first connector for an electrical connection, in the use of the plasma generator in the weapon system, to a respective second connector, interacting with the respective first connector, on the back piece of the weapon system, wherein the connector belonging to the combustion chamber and the connector belonging to the center electrode are axially displaceable relative to each one of the connectors belonging to the back piece, with a maintained, radical contact, via each lamellar contact, between the first and the second connectors during the axial displacement.

2. The plasma generator as claimed m claim 1, wherein the connector belonging to the combustion chamber and the connector belonging to the center electrode, together with one each of the connectors of the back piece, each constitute a respective connector pair, which connector pairs each comprise, disposed on their respective connector, a radially disposed, electrically conductive lamellar contact and a radially disposed, electrically conductive sliding surface, interacting with the lamellar contact, which lamellar contact and sliding surface are axially displaceable relative to each other to produce said maintained, radial contact between the first and the second connectors during the axial displacement.

3. The plasma generator as claimed in claim 2, wherein the lamellar contacts are disposed one on the connector belonging to the combustion chamber and one on the connector belonging to the center electrode, and the sliding surfaces are disposed one on one each of the connectors belonging to the back piece.

4. The plasma generator as claimed in claim 1, wherein the combustion chamber channel extends axially through the combustion chamber, in that a flange is disposed on an outer, rear end of the combustion chamber, in that an orifice closure is disposed on a front end of the combustion chamber, in that an electrically insulating ceramic tube is disposed inside the combustion chamber channel between the rear end of the combustion chamber and the orifice closure, and in that the electrically conductive center electrode is disposed inside the electrically insulating ceramic tube.

5. The plasma generator as claimed in claim 4, wherein the connector of the combustion chamber is comprised of an outer lamellar contact disposed on the flange of the combustion chamber and in that the connector of the center electrode is comprised of an inner lamellar contact disposed inside the center electrode.

6. The plasma generator as claimed in claim 5, wherein the outer lamellar contact comprises an outer lamellar contact strip, which is fitted radially on the flange.

7. The plasma generator as claimed in claim 6, wherein the outer lamellar contact strip is fitted in a radial groove enclosing the periphery of the flange.

8. The plasma generator as claimed in claim 6, wherein the outer lamellar contact strip is comprised of a conductive material.

9. The plasma generator as claimed in claim 6, wherein the outer lamellar contact strip comprises resilient lamellae for providing good bearing contact against the therewith interacting connector on the back piece, in which connector the flange is intended to be inserted over a certain set axial distance, preferably exceeding the flange thickness.

10. The plasma generator as claimed in claim 5 wherein the inner lamellar contact comprises a cavity arranged inside the center electrode and intended for the connector of the back piece, and an inner lamellar contact strip fitted on the radial inner surface of the cavity.

11. The plasma generator as claimed in claim 10, wherein the inner lamellar contact strip comprises resilient lamellae for providing good bearing contact against the therewith interacting connector on the back piece, which connector is intended to be inserted in the cavity by a certain set axial distance, preferably exceeding the thickness of the flange.

12. The plasma generator as claimed in claim 10, wherein the inner lamellar contact strip is comprised of a conductive material.

13. A method pertaining to a plasma generator for electrothermal and electrothermal-chemical weapon systems, which plasma generator comprises a combustion chamber having a combustion chamber channel, and a center electrode disposed inside the combustion chamber channel, which combustion chamber and center electrode are electrically conductive and each comprise a respective first connector for an electrical connection, in the use of the plasma generator in the weapon system, to a respective second connector, interacting with the respective first connector, on the back piece of the weapon system, in order to prevent the contact of the plasma generator with the back piece of the weapon system from being broken by vibrations and recoils occurring in connection with the use of the weapon system, through the formation of an axial clearance between the first connectors on the plasma generator and the second connectors on the back piece of the weapon system, characterized in that the connector belonging to the combustion chamber and the connector belonging to the center electrode, upon said vibrations and recoils, are axially displaced relative to each one of the connectors belonging to the back piece, so that the axial clearance is formed, at the same time as an unbroken contact is maintained radially between the first and the second connectors during said axial displacement.

14. The method as claimed in claim 13, wherein the maintained, unbroken contact between the first and the second connectors is made possible by the fact that the connectors of the combustion chamber and of the center electrode bear against and interact with one each of the connectors of the back piece along a radial contact surface whose axial width exceeds the axial clearance between the first and the second connectors, to which the use of the weapon system gives rise.

15. The method as claimed in claim 13, wherein the maintained, unbroken, radial contact between the first and the second connectors, in which the connector belonging to the combustion chamber and the connector belonging to the center electrode, together with one each of the connectors belonging to the back piece, form a respective connector pair, is realized by the fact that, arranged one on one each of the first connectors and one on one each of the second connectors in each connector pair, a radially disposed, electrically conductive lamellar contact bears against and interacts with a likewise radially disposed, electrically conductive sliding surface, which lamellar contact and sliding surface are axially displaced relative to each other such that said maintained, radial contact between the first and the second connectors is achieved during the axial displacement.

16. The plasma generator as claimed in claim 2, wherein the combustion chamber channel extends axially through the combustion chamber, in that a flange is disposed on an outer, rear end of the combustion chamber, in that an orifice closure is disposed on a front end of the combustion chamber, in that an electrically insulating ceramic tube is disposed inside the combustion chamber channel between the rear end of the combustion chamber and the orifice closure, and in that the electrically conductive center electrode is disposed inside the electrically insulating ceramic tube.

17. The plasma generator as claimed in claim 3, wherein the combustion chamber channel extends axially through the combustion chamber, in that a flange is disposed on an outer, rear end of the combustion chamber, in that an orifice closure is disposed on a front end of the combustion chamber, in that an electrically insulating ceramic tube is disposed inside the combustion chamber channel between the rear end of the combustion chamber and the orifice closure, and in that the electrically conductive center electrode is disposed inside the electrically insulating ceramic tube.

18. The plasma generator as claimed in claim 7, wherein the outer lamellar contact strip is comprised of a conductive material.

19. The plasma generator as claimed in claim 8, wherein the conductive material comprises copper.

20. The plasma generator as claimed in claim 7, wherein the outer lamellar contact strip comprises resilient lamellae for providing good bearing contact against the therewith interacting connector on the back piece, in which connector the flange is intended to be inserted over a certain set axial distance, preferably exceeding the flange thickness.
